(19) United States
(12) Patent Application Publication
(10) Pub. No.: US 2009/0314193 A1
(43) Pub. Date: Dec. 24, 2009

(54) Ultra-Sonic Device

(75) Inventors: Stephen Groves, Reading (GB); David Price, Reading (GB); Gavin Sneddon, Hindon (GB)

Correspondence Address: BARNES & THORNBURG LLP, P.O. BOX 2786, CHICAGO, IL, 60690-2786, US

(73) Assignee: Blue & Green Marine Limited, Buckinghamshire (GB)

(21) Appl. No.: 12/484,559

(22) Filed: Jun. 15, 2009

(30) Foreign Application Priority Data
Jun. 14, 2008 (GB) 0810904.3
Sep. 11, 2008 (GB) 0816629.0
Apr. 20, 2009 (GB) 0906879.2

(51) Int. Cl. B63B 59/08; B06B 1/00; B06B 1/06

(52) U.S. Cl. 114/222

(57) ABSTRACT

The present invention relates to an ultra-sonic device, which can be utilised in an aquatic environment to inhibit growth of waterborne flora and fauna. In particular, the present invention relates to a method of reducing such growth and the removal from the underside of yachts, boats and the like. In general, the present invention relates to anti-fouling systems as are known to prevent biological growth such as algae, seaweed and crustacea on marine vessels or underwater structures. Coating materials have been developed preventing corrosion due to oxidation of the surface of the structure. Although such materials have effects of retarding growth of the corrosion, however, they contain zinc, lead, copper, etc, raising a problem of environmental pollution due to dissolution of these metals into seawater. In addition, none of these coating materials can prevent clinging of marine organisms, and if they cling to the structure, oxidation is accelerated by oxygen sent out from the marine organisms, causing further growth of the corrosion of the structure. The formation of encrustations of barnacles, tunicates, and like fouling organisms, will increase the vessel's weight, thereby decreasing the available storage space, slow a vessel underway, increase its fuel consumption, and make it difficult to handle, thus reducing the vessel's performance and efficiency. The present invention addresses this need wherein the transducer is operable on a cyclic basis.

### FIELD OF INVENTION

The present invention relates to an ultra-sonic device, which can be utilised in a marine environment to inhibit growth of waterborne fauna and flora. In particular, the present invention relates to a device and method of preventing, reducing and removing such growth from the underside of yachts, boats and the like. In general, the present invention relates to anti-fouling systems as are known to prevent biological growth such as algae, seaweed and crustacea on marine vessels or underwater structures.

### BACKGROUND TO THE INVENTION

Coating materials have been developed preventing corrosion due to oxidation of the surface of aquatic structures. Although such materials have effects of retarding growth of the corrosion, however, they contain zinc, lead, copper, etc, raising a problem of environmental pollution due to dissolution of these metals into seawater. In addition, none of these coating materials can prevent the clinging of marine organisms, and if they cling to the structure, oxidation is accelerated by oxygen sent out from the marine organisms, accelerating corrosion of the structure.

Fouling of marine vessel hulls and other structures in a marine environment has always been a serious problem—in respect of both sea-going and inland water vessels. The formation of encrustations of barnacles, tunicates, and like fouling organisms, will increase the vessel's weight, thereby decreasing the available storage space, slow a vessel underway, increase its fuel consumption, and make it difficult to handle, thus reducing the vessel's performance and efficiency. It is to be understood that the term marine in relation to algae, weed etc. in this document includes inland water algae, weed etc. i.e. this document relates to waters that are not only sea waters. On fixed structures, fouling increases weight, and thus structural loading. Fouling also damages the vessel hull base paint, thereby exposing the hull to corrosion. The effect of fouling on pipeline paraphernalia, oil rig platforms, underwater observatories, hydroelectric plants and the like can be equally damaging and potentially dangerous, for example when an oil faucet cannot be closed, an oil rig safety-element cannot be deployed etc. Equally, at jetties, harbours, marinas and the like seafarers alighting from or providing provision for a boat or ship can be disadvantaged by having fouling of tidal walkways, steps and the like. Such walkways may even be dangerous, especially when waves may cross the walkways. Indeed, a variety of structures including buildings and ships have been placed in the ocean for development of natural resources such as biological, oil, gas and mineral resources, for exploitation of ocean energy, ocean space, seawater, etc, for preservation of environment, etc, or for industrial applications for marine transport, harbour, marine product industry, etc.

Algae are a diverse group of plants that occur in a wide range of environmental habitats. They are photosynthetic plants that contain chlorophyll, have simple reproductive structures, and their tissues are not differentiated into true roots, stems or leaves. They range from unicellar, or single cells, to fairly complex multicellular organisms. Certain algae have such a complex growth that they are mistaken for vascular plants—Chara would be one such example. The size of average individual microscopic unicellular algal plants is approximately 0.0010 mm in diameter. Algae are found throughout the world and can cause nuisance problems in oceans, rivers, water treatment plants, drinking water supplies, receiving water ponds, swimming pools and cooling towers. The extermination of algae is a problem, which has kept man busy since time immemorial. Algae are microscopic single-celled forms of plant life which thrive in sunshine. They are present on vegetation, in the air, in the soil, and in water. Their microscopic spores are continuously introduced into pools and other bodies of water by wind, dust storms, rain showers, etc. They grow rapidly in stagnant waters when exposed to sunlight and temperatures above 4° C. They can form objectionable slime and/or odours. They can interfere with proper filtration and greatly increase chlorine demand. Phosphates and nitrates in the water encourage their growth. Algal growth occurs in three basic forms: planktonic, filamentous and macrophytic.

Algal slime is not a true algae but a cyanobacteria. The simplest forms of cyanobacteria are the unicellular chroococcales. They reproduce by binary fission (splitting in two, then again in two, and this process is repeated over and over). Some split and do not remain together and become free floating. Others, as in Microcystis agglomerate and make up a large colony held together by a slimy mass. What you see, in essence, is not an alga but literally thousands upon thousands of them, all bound by the slime—the latter being what you see, not the individual algae. Remember they are so small that even normal strong microscopes cannot detect them. This cyanobacteria, commonly referred to as slime algae, often form long cell chains that result in a blanket-like slime that covers everything on a ships bottom. Since it reproduces asexually by cell division, it takes over very rapidly. It is usually a dark green to a dark red and starts out as small dark spots on the bottom. A slime algae bloom is difficult to get rid of.

A slime algae outbreak is typically caused by a sudden change in water temperature or conditions. A quick addition of nitrogen gas will feed the algae. As light spectrums change they often supply the right type of light to feed the cyanobacteria. Normally, slime algae are caused by an accumulation of nutrients and biological imbalance from the result of poor filtration, lack of oxygen, or high bio load. Cyanobacteria have even been noted to enter the water as spores from the air.

The fouling of a vessel's hull can be removed while the vessel is in place or in dry-dock using mechanical and/or chemical means. However, these alternatives are frequently unavailable, or are available only after a long wait. When a vessel hull or structure is cleaned in place, it is common practice to use divers, however there are inherent dangers whenever a diver enters the water. Additionally, damage may occur whenever a diver cleans a hull or structure. When a vessel hull is cleaned in dry-dock, the vessel must be taken out of service to the nearest available dry-dock, which usually results in substantial adverse financial consequences due to the costs, not only for the required work, but also for the off-hire time. Furthermore, removal of encrustations of marine organisms while at dock can raise significant regulatory and environmental concerns. It is impractical to remove fixed structures from site for cleaning. It is believed that algal growth is the pre-cursor to the colonisation of barnacles, weeds etc., the oxygen given off by the algae enabling the growth of such other organisms.

Remedies that have previously been tried include using toxic paints that slowly release marine growth inhibitors such as copper or tin salts, or using silicone based paints, which are ultra-smooth, making it difficult for fouling organisms to adhere to the surface of the vessel hull. These methods are effective until the inhibitors are leached from the paint, or the paint is damaged, and fouling takes place again, requiring dry-docking of the vessel to remove the fouling material and to repaint the hull. Also, these anti-fouling agents remain in the marine environment for a long period of time. Therefore, the most toxic of the anti-fouling coatings are being banned worldwide and are being replaced by less toxic, but also less effective coatings. For structures and vessels expected to operate in a marine environment for a long period of time, such as Floating Storage and Offloading vessels (FSOs) or Floating, Production, Storage and Offloading vessels (FPSOs), fouling is an even greater problem. Additionally, many heavy-metal based paints formally employed for such purposes are now banned by many national and supra-national governing bodies.

Due to their simplicity, algae cells are very basic and therefore most cells are weak. Controlled ultrasonic waves with short periodic interruptions, target the vacuole (centre) of the algae cell, rupturing the vacuole and causing the algae cell to collapse in on itself. Research has also shown that the ultrasonic waves kill other harmful fungi and restrict bacterium such as legionella from multiplying.

Another approach for controlling and preventing marine fouling involves using an anti-fouling system that includes a pair of electrodes positioned on opposite sides of the keel of a vessel, and a means for supplying an electrical current to the electrodes. The electrolysis of sea water produces toxic agents such as chlorine and sodium hypochlorite adjacent the vessel hull that remove barnacles, algae, fungi and other marine growths.

However, such systems do not provide predictable control of the concentration of anti-fouling composition delivered to the hull. In addition, the electrodes require regular maintenance, which may be difficult since the electrodes are positioned on the outside of the vessel hull adjacent the keel.

Other types of anti-fouling exist, such as the use of hypochlorite of sodium through tubing disposed external of the hull. CA2618925 provides a water-based anti-fouling paint composition which has anti-fouling effects in seawater and which, allegedly, has minimal effect on the environment and on the operators because organic solvents are essentially not included.

U.S. Pat. No. 6,285,629 provides an ultrasonic vibration device; a voltage is applied to a submerged marine structure to exert thereon vibrational and electric energies, thereby effecting deterioration prevention of the structure. An ultrasonic vibration unit comprises an ultrasonic vibrator made from a piezoelectric ceramic plate with an electrode on each side thereof; power supply wires connected to the respective electrodes; a support member for fixedly supporting the ultrasonic vibrator and transmitting the ultrasonic vibration to the structure; and a resin coat for protecting the ultrasonic vibrator against seawater. The ultrasonic vibration unit is used for preventing deterioration of the submerged marine structure.

U.S. Pat. No. 5,143,011 provides a system for inhibiting growth of barnacles and other marine life on the hull of a boat. The system includes a plurality of transducers or vibrators mounted on the hull and alternately energized at a frequency of 25 Hertz through a power source preferably the boat battery, and a control system. The system has two selectable operating modes one being continuous and the other being operational through daylight hours only. Also when the voltage of the battery falls below a predetermined level, transducers are automatically de-energized.

U.S. Pat. No. 5,532,980 provides loudspeaker-like resonators which operate underwater and produce acoustic vibrations continually having a duty cycle of 3.65 seconds which includes a current drive period of 0.4 seconds. WO01/58750 provides an ultrasonic anti-fouling device which teaches of devices that are hung outside a hull and arranged so that the vibrations are directed to run parallel to a surface of the hull. A duty cycle of a few to several tens of seconds, with a current drive period of less than a second; the device operate over a broad range of frequencies, being 20 KHz-100 KHz. U.S. Pat. No. 5,735,226 teaches of a marine anti-fouling system which continually powers a vibrational device at a frequency between 25 KHz and 60 KHz, some of the signal being enhanced by the driving of subatomic frequencies superimposed on the ultrasonic signals.

However, ultrasonic systems are not without their basic problems of high initial cost and continual need for an electrical power supply, either from a boat's internal electrical battery—which would need to be maintained in a charged state—or an external marina based power supply, which may be rated at a nominal alternating current domestic power supply or a low voltage direct current supply at either 12 or 24 Volts. Equally, for craft over 7-8 m then it has been the experience of operators of such craft that a single ultrasonic transducer is not sufficient to prevent fouling. It has also been shown that the use of multiple transducers upon a single boat can tend to reduce the overall effect because of the effect of standing waves produced as a result of the contemporaneous use of two or more transducers.

### OBJECT OF THE INVENTION

The present invention seeks to provide a solution to the problems addressed above. The present invention seeks to provide a system for the provision of an effective, economical ultrasonic transducer based antifouling system. The present invention seeks to provide a boat based ultrasound anti-fouling system which can provide effective anti-fouling with reduced operating costs, both financially and in terms of input power requirements. The present invention also seeks to provide a system that can be modularised, whereby economies of scale in manufacturing can be enabled.

### STATEMENT OF INVENTION

In accordance with a first aspect of the invention, there is provided an anti-fouling arrangement for a boat, the arrangement comprising a controller, an ultra-sonic transducer and a transducer driver, wherein the controller provides control signal for the transducer driver whereby the transducer can be driven at its operating frequency and voltage, wherein the transducer is operable on a cyclic basis having an on period of between 10 and 60 seconds followed by an off period of between 5 and 60 minutes.

It has been found that by having cyclical periods within the above ranges, effective anti-fouling systems can be provided whereby continuous drain on electrical supplies need not be necessary. It has been determined that a 15 seconds on period with an off period of 10 minutes has provided satisfactory results for steel hulled boats in Pacific ocean based boats in the region of Australia and New Zealand. It will be appreciated that the level of anti-fouling that is necessary is dependent upon the number of factors, including, but not limited to, geographical location—which will, for a given date in a year have specific hours of daylight; have particular degrees of salinity; have particular levels of pre-existing marine fauna and flora; have particular ranges of temperature. In a preferred embodiment, the controller determines the level of cycles necessary dependent upon such data, which may be retained in memory, for example from GPS data or by contemporaneous feedback. This can be of extreme benefit, when, for example a boat is maintained at a mooring, without regular visit by crew, for example at the beginning or toward the end of a season, when the temperature is reduced and the hours of daylight are reduced.

The present invention also provides an improved method of operation, whereby the system operates with a feedback mechanism at the beginning of each new cycle, every five to sixty minutes. In temperate waters, during summer conditions, it has been found that an on-period of 30 seconds every 10 minutes has provided sufficient duration to prevent growth of marine fauna and flora on glass-reinforced plastics and aluminium hulls. In particularly warm waters, the duration of the off period may need to be reduced to 5 minutes. Upon receiving an instruction signal to operate, it is preferred that the transducer driver receives feedback signals whereby to obtain maximum power for a given input voltage/power value, the feedback system operating on a self-optimising routine whereby to achieve maximum output power at resonance taking into account operating conditions.

Conveniently, the ultra-sonic transducer is a piezo-electric transducer. Ultra-sonic piezo-electric transducer devices are readily available and have a good reliability record and can be installed in relatively hostile, typically highly saline, conditions of a bilge area within a boat. Notwithstanding this, the present invention is preferably encased in a machined housing, the material conveniently being manufactured from an anodised aluminium alloy, although contact with hull materials having a different Galvanic value is not considered to be beneficial. The transducer can be inserted in a flange arrangement, which has a through-hull fitment, whereby to provide a closed end face which can lie at or just below the surface of the hull, the inside of the closed end face being in an acoustically coupled arrangement with the ultrasonic face of the transducer element. This type of flange is suitable for hulls which have a double skin or are made from certain types of wood.

The power supply can operate from a 12V or 24 V dc supply derived from a low voltage power supply employed to operate the electrical circuits within the boat. Equally, voltage down conversion and current rectification components can be provided whereby a marina/harbour mains supply system can be utilized.

Preferably, the transducer is driven by a driving circuit that includes a detector and a feedback circuit, the detector being operable to monitor output power whereby to vary a frequency of operation until a resonant maximum output is achieved. The system is tuned on for each cycle of operation and the feedback circuit is brought into operation whereby factors such as temperature are taken into account by virtue of the resonator circuit determining maximum power, which occurs at a resonance of the system, which will vary from device to device. Preferably, the control unit operates by providing control signals to each transducer in turn. This has the advantage that interference between different transducers does not take place.

Conveniently, the systems has a control circuit, the control circuit having a fault detection circuit that is based around pre-set parameters based upon operational characteristics of a particular transducer. If a transducer becomes open circuit, i.e. a cable is damaged or the unit becomes faulty taking too much or too little current then the fault light is illuminated and power switched off to that output position. This circuit will reset during the next cycle if the transducer is removed/repaired.

Conveniently, the ultra-sonic transducer is a piezo-electric transducer. Ultra-sonic piezo-electric transducer devices are readily available and have a good reliability record and can be installed in relatively hostile, typically highly saline, conditions of a bilge area within a boat. Notwithstanding this, the present invention is preferably encased in a machined housing, the material conveniently being manufactured from an anodised aluminium alloy, although contact with hull materials having a different Galvanic value is not considered to be beneficial.

In accordance with a still further aspect of the invention, there is provided a method of reducing the build-up of fouling of a boat, the arrangement comprising a controller, an ultra-sonic transducer and a transducer driver, wherein the controller provides control signals for the transducer driver whereby the transducer can be driven at its operating frequency and voltage, the method comprising the steps of operating the transducer on a cyclic basis having an on period of between 10 and 60 seconds followed by an off period of between 5 and 60 minutes. Preferably, the transducer is driven by a driving circuit that includes a detector and a feedback circuit, the detector being operable to monitor output power whereby upon start-up, the method also includes the step of tuning the frequency of operation until a maximum output power is achieved. The system is therefore tuned for each cycle of operation and the feedback circuit is brought into operation whereby factors such as temperature are taken into account by virtue of the resonator circuit determining maximum power, which occurs at a resonance of the system, which will vary from device to device. Where there is more than one transducer, it is preferred that the transducers are operated in sequence rather than one or more operating simultaneously.

### BRIEF DESCRIPTION OF THE FIGURES

For a better understanding of the present invention, reference will now be made, by way of example only, to the Figures as shown in the accompanying drawing sheets, wherein:—

FIG. 1 illustrates a first embodiment of the invention;

FIG. 2 details functional components of the transducer driver circuit;

FIG. 2a shows a driver/transducer system;

FIG. 3 shows a yacht with a further embodiment of the present invention, with secondary sensors and detectors;

FIG. 4 indicates the position where measurements were made on a test boat;

Table 1 indicates the level of algal activity during a five month period of testing;

Table 2 is a graph indicating the levels of chlorophyll on the test boat with regard to control plates; and,

FIGS. 5a and 5b show a typical transducer.

### DETAILED DESCRIPTION OF THE PREFERRED EMBODIMENTS

There will now be described, by way of example only, the best mode contemplated by the inventor for carrying out the present invention. In the following description, numerous specific details are set out in order to provide a complete understanding of the present invention. It will be apparent to those skilled in the art, that the present invention may be put into practice with variations of the specific.

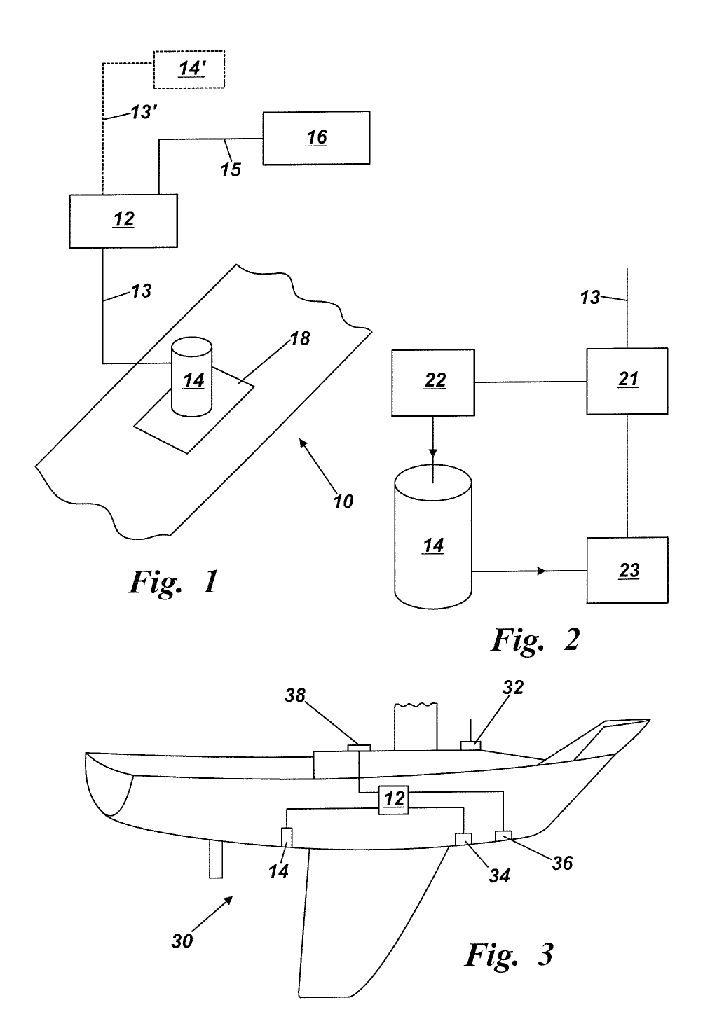

Referring now to FIG. 1, there is shown a first embodiment of the invention wherein there is shown an ultrasonic antifouling system for a boat, wherein there is provided a controller 12, which is connected to a power supply 16 via power lead 15. The power supply is conveniently a 12V or 24 V dc supply derived from a low voltage power supply employed to operate the electrical circuits within the cabins, navigation lights and so on. Conveniently, there is also provided a 120/230/240V input circuit operable to receive domestic alternating power supplies as are frequently provided at harbours, marinas and the like, whereby to reduce current drain on an internal battery/other power supply of a boat. An ultrasonic transducer 14 is connected to the controller via input line 13, the transducer being connected to the hull, conveniently via an acoustic couplant such as virgin castor oil or a specific grease for such applications, for example A-186 grease available from Dwyer Instruments Inc. Michigan City, Ind., USA, the grease providing good sonic coupling from an out face of the transducer to the hull. The control line delivers signals for operation where an input unit conditions the input signal voltage, which voltage signal is amplified by a power amplifier with a matching circuit to provide signals to drive the transducer. Dotted line 13′ and box 14′ indicate one or more secondary transducers, which may be employed for a given boat with regard to its size.

Ultrasonic couplants facilitate the transmission of sound energy between the transducer and the hull. Couplants will typically be viscous, nontoxic liquids, gels, or pastes. Their use is necessary because sound energy at the ultrasonic frequencies typically used are not effectively transmitted through air. Aside from attenuation effects, air represents a severe acoustic impedance mismatch with respect to both transducer output faceplates and typical materials to be treated. Even an extremely thin air gap between the transducer and a hull will prevent efficient sound energy transmission. Liquid couplants generally provide lower acoustic impedance but often offset this with the ease of application and the ease with which air can be forced out. On a smooth surface they can offer good longitudinal wave transmission, comparable to gel type couplants and adhesives. Gel type couplants will usually provide a slightly higher acoustic impedance than liquid based couplants, the most common ones being ultrasonic gel or glycerin. The higher viscosity of gels over liquids does make them more appropriate on rougher surfaces where the filling of gaps is required. Many gel type couplants will dry out over time, particularly around the edge of the sensor. Due to their relatively low viscosity they are very good at forcing out trapped air from the contact region with a small amount of force on the sensor. Bonding agents can be used as an acoustic couplant that physically attach the sensor to the measurement surface. Glycerin is also a general purpose couplant with both advantages and disadvantages as compared with propylene glycol. An advantage of using glycerin is that it is more viscous compared with propylene glycol and has a higher acoustic impedance, making it a preferred couplant for rough surfaces and highly attenuating materials. Glycerin has an acoustic impedance of 2.42×105 gm-cm2/sec (versus 1.61 for propylene glycol, approximately 1.5 for motor oil, and 1.48 for water). Castor oil is not water soluble nor is it particularly susceptible to drying out, foaming or becoming rigid and has been found to be a readily available product which lends itself to use in the present invention where surfaces are not particularly rough. Castor oil has the advantage of being a readily available product.

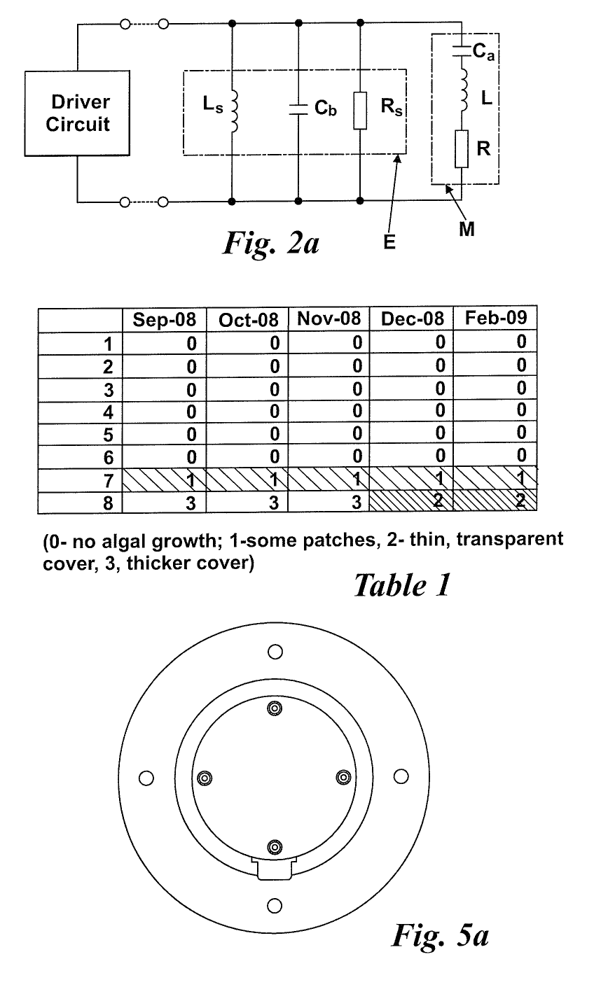

Referring now to FIG. 2, there is shown the component features of the driving circuit associated with each transducer 14. Control signal line 13 from controller 12 receives a voltage feed for the transducer and a signal line whereby to drive the transducer. The driver circuit includes a detector. Applicants have devised a feedback circuit which is operable to monitor output; upon start-up of the transducer (for each cycle of operation), factors such as temperature are taken into account by virtue of the resonator circuit determining maximum power, which has been found to correspond to 39.8 KHz, although this maximum will depend on the exact mode required for the application; input power may be reduced for a reduced effective coverage, as could be the case for smaller boats. Indeed, the maximum is also believed to be determined, in part, by reason of a resonance associated with the hull or body associated with the transducer. There will be a specific resonant impedance and frequency for each transducer. The driver for the transducers operates in a particular fashion whereby efficiency is maximised, with the transducer operating as efficiently as possible. The control unit itself powers the transducers in sequence for a “pre-set transmit duration” followed by an off state. This “on” time is repeated for each transducer connected in turn. The controller detects the transducers that are connected so will only power up the relevant output positions. This prevents the controller from cycling redundant outputs, thus reducing its own power consumption.

The Control unit has a fault detection circuit that is based around pre-set parameters based upon operational characteristics of a particular transducer. If a transducer becomes open circuit, i.e. a cable is damaged or the unit becomes faulty taking too much or too little current then the fault light is illuminated and power switched off to that output position. This circuit will reset during the next cycle if the transducer is removed/replaced, or will continue to show the fault if unrectified. Other output positions remain unaffected during a fault condition, and remain operational, continuing their cycle.

The transducers require no power while in their quiescent “off” state and, when turned on by the controller, instantly perform a “calibration sweep” across a predetermined tight frequency range. This allows the unit to re-align itself around its exact resonance, compensating for ambient and self temperature changes, as well as other mechanical characteristic changes that may “shift” the resonant frequency away from its spec frequency, as well as transducer tolerances.

This may only amount to small changes in the control frequency but makes significant improvements to the efficiency of the units by massively reducing power consumption, harmonics and mechanical noise, and output heat. This action is repeated on every cycle on every transducer. This type of control being effected within the transducer itself (which has local software control) also means that the units are not affected by long or short cable lengths, and minimise the likelihood of transmitted electrical noise to other equipment via such cable runs. The implications for maintaining battery in an operable state between charging; equally there is a corresponding reduction on any other source of electrical energy.

To reduce the current demand on the driver circuit due to possible large reactive currents in C_{b}, the accepted practice is to shunt C_{b} with inductance, Lₛ, to produce a second combination resonant at frequency Fᵣ. The value of Lₛ is calculated from:

$$\frac{1}{4 {π}^{2} {F}_{r}^{2} {C}_{b}}$$

The complete driver/transducer system thus appears as FIG. 2a, where M is the mechanical equivalent circuit, E the electrical compensating circuit and Rs is the shunt resistance, which may arise from the configuration of the various components in the circuit or may arise through the use of specific resistances placed in the circuit. In order to maximise power transfer at a given voltage, it is also necessary to ensure that the driver circuit output impedance is matched to the resonant impedance of the compensated transducer. To this end, shunt resistance, Rₛ, is sometimes added to the compensation circuit to optimise impedance matching. The design of the driver is crucial to the successful operation of any resonant transducer system. The prime requirement is to supply electrical power at a well-controlled frequency thus minimising the voltages required to deliver a specified power.

The voltage output from the driver circuit can vary sinusoidally or as a square wave according to circuit design, and where voltage levels demand it, power may be supplied via an output transformer which can also provide a floating output if this is necessary. The step up transformer can be provided with a ratio of 10 primary turns to 70 secondary turns for an aluminium pod and 10 primary to 120 secondary turns for a stainless steel pod one. This has shown to provide optimum drive, as too little step up reduces output and too much step up converts the excess energy into noise and heat.

It is preferred that in operation, the driver will self-tune the frequency to match the transducer system. This is best achieved by arranging the equivalent circuit components to form the frequency determining element in the driver oscillator circuit. Self-tuning drivers are essential when driving high intensity devices which will have very high ‘Q’ resonances, and operation at frequencies off Fᵣ will result in a marked drop in delivered power under constant drive voltage conditions.

One transducer that has been employed in tests is a 40 KHz ultrasonic transducer manufactured by Ultrasonics World, which are of a type generally manufactured for applications such as the manufacture of laboratory ultrasonic cleansing devices, This 50 W (continuous operation) device has been driven on a limited duration cycle of 30 seconds on, followed by an off period of ten minutes. By operating the device at such a low duty cycle, the period for discharge of a battery provided to power the system is extended significantly. Moreover, by operating the transducer for a maximum level during use, then the acoustic irritation to fauna and flora is sufficient to prevent growth. Indeed, in tests, it has been shown for hulls that have been subject to testing to have pre-existing encrustations of barnacle growth and algal growth removed by scavenging fish and other marine organisms. In temperate waters, during summer conditions, it has been found that an on-period of 30 seconds every 10 minutes has provided sufficient duration to prevent growth of marine fauna and flora on glass-reinforced plastics and aluminium hulls. In particularly warm tropical waters, the duration of the off period may need to be reduced to 5 minutes.

Conveniently, the controller unit is placed where a check on the functioning can be easily be performed, for example near a tiller or cockpit of a boat. Conveniently, the controller provides a LCD display operable to confirm that the unit is operational (or not), which power supply is being used, whether external or internal—or indeed whether a power feed from an engine is being employed: an indication of the available charge in the battery etc Whether the power is obtained from an external source or otherwise, the input voltage is conveniently protected against surges upon initial connection and possible incorrect polarity; in the case of a domestic alternating voltage power supply rectification and voltage down conversion circuits are present. The controller may drive one or several transducers, which is dependent upon the application.

Research has determined that ultrasonic transducers operating in the region of 38-42 KHz, when mounted upon the inside of the hulls of yachts have been particularly efficient in reducing algal growth. An ultrasonic transducer is a device that converts energy into ultrasound, or sound waves above the normal range of human hearing. The term generally is used in relation to piezoelectric transducers that convert electrical energy into sound. Piezoelectric crystals have the property of changing size when a voltage is applied, thus applying an alternating voltage (AC) across them causes them to oscillate at very high frequencies, thus producing very high frequency sound waves.

The transducers according to the present invention operate by killing substantially all types of algae including the Blanketweed (spirogyra), the potentially deadly Blue-Green algae (cyanophyta) and the fast growing Cladophora. This algaecide action arises through the creation of ultrasonic cavitation. Ultrasonic cavitation is the momentary creation of vacuum “tears” commonly referred to as “bubbles” in the fluid which immediately and violently implode to produce millions of microscopic jets of liquid which gently scrub the surface of the vessel and break the cell walls of the algal slime. In addition, local temperatures near this activity has been shown to be as high as 10,000° C., and the pressure produced may be as high as 10,000 psi. These tears or cavities are created tens of thousands of times each second to gently remove contaminants and destroy algal slime without damage to a boat. As long as the ultrasonic frequency selected is correct for the application. (At 40 kHz, cavities are generated 40,000 times each second.)

Although these cavities are produced by the millions, the distribution of these cavities is determined by the ultrasonic frequency in operation. Every ultrasonic cleaning system produces a cleaning action that is distributed as a series of equidistant bands of activity. These bands are known as “standing waves”, and cleaning action between standing waves is only a fraction of the energy which is produced at a standing wave location. This is why selection of the appropriate ultrasonic frequency is so important to developing an effective cleaning process. The frequency selected must produce a distribution of cavitation which ensures that the entire ship is successfully cleaned.

Sound waves are composed of 2 actions; an expansion cycle during which the liquid molecules are being pulled apart, and a compression cycle, during which the molecules are being compressed. If the expansion cycle of the wave has enough energy to overcome the forces which hold the molecules of liquid together, a cavity is produced. Immediately following the expansion cycle, the compression cycle follows, rapidly compressing the cavities created.

Different regions of the world, however, will have different weather conditions and different geological conditions. In turn, the conditions for marine life will differ, due to, for example, water salinity (due to both sodium chloride and other dissolved salts), water temperature, daylight hours etcetera. This means that optimum conditions for marine growth will vary, dependent upon latitude and longitude, feeder rivers etc. For example, in seas such as the Mediterranean and the Caribbean, the water temperature is much higher than in, for example, the North Sea, the Baltic etc and so operating cycles will need to vary depend upon the likelihood of growth. For example, in the absence of daylight, many algal growths will cease to grow and will effectively be asleep; they will not attach themselves to structures during the night.

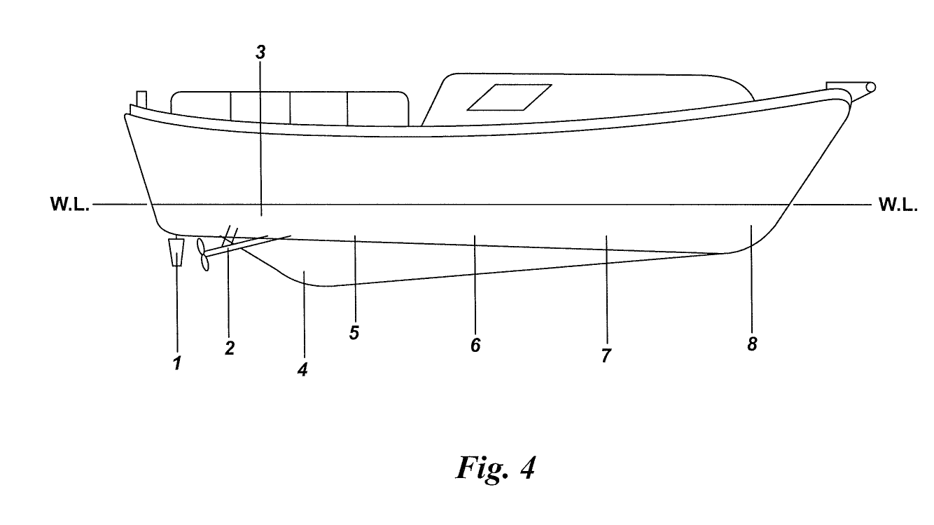

With reference to FIG. 3, there is shown a further embodiment having further aids to help determine preferred operational conditions of the ultrasonic device. Yacht 30 is provided with controller 12 and transducer 14 as before: GPS arrangement 32 is provided: data obtained from the geographical location will enable the controller to refer to a look-up table (not referenced) whereby for a given time of the year and hour of the day, operating conditions of the transducer can be optimised, whereby to prevent growth of marine flora and prevent attachment of marine fauna. It is also possible, using salinity detector 34, temperature sensor 36 and ambient light sensor 38 to optimise operation of the transducer.

Applicants have realised that for effective operation of an ultrasonic transducer, the mode of operation need not be continuous. This fundamental issue has been used to develop a low energy ultrasonic system. A further advantage of this is that, given that a single transducer is sufficient to protect a small boat, say up to 6 m if made of steel, for larger boats, two or more transducers may well be appropriate. It has been determined that two 50 W ultrasonic transducers, when placed in acoustic contact with a hull, can be placed between 5-10 m apart. As will be appreciated, a more powerful transducer will increase an effective range of protection; equally, the propagation characteristics of the transducer will not be omni directional and consideration should be made to optimisation of each and every installation. A typical set-up could operate as follows, for a four transducer system as would be suitable for many craft of the order of 10 m in length: each transducer would transmit at a current of 0.6 Amps for every 30 seconds in 10 minutes: accordingly this would equate to a duty cycle for four transducers of 3 mins battery consumption, which taking onto account controller current drain would mean current drain of 0.14 Amps average; for a 110 Amp battery, this would enable power to be provided for approximately 785 hours, which is equivalent to 32 days. Whilst this equation is simplistic, it means that antifouling protection can be simply and economically provided; systems can be left for weeks on end, providing much relief to boat owners. As will be appreciated, with the use of solar panels, this time period could be extended quite simply. The system can be extended to merchant vessels current drain on a ships power supply can be reduced significantly.

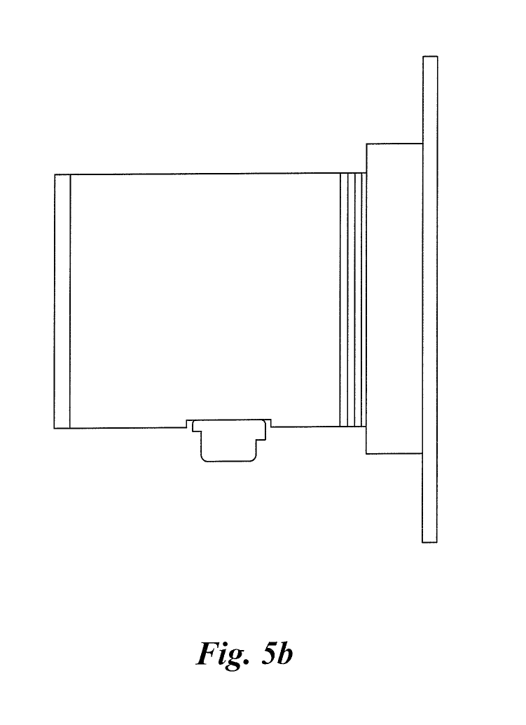

With reference to FIGS. 5a and 5b, there is shown in plan view (with reference to when mounted to a hull) and side view a transducer and mounting flange. The diameter of the flange can be conveniently compact, for example 14 cm, with the axial length of the transducer being less than 12 cm. In fitment of the device the flange is coupled to the hull first. This can be by welding, in the case of steel hulls, although difficulties in welding due to differences in the composition of the flange (conveniently a marine-grade stainless steel such as 316). However the flange may also be manufactured from an anodised aluminium alloy. Those skilled in the art will realise that different metals are not galvanically in contact with each other, whereby to affect the performance of the ultrasonic transducer. The flange must be soundly connected to the hull. It is preferred that the transducer mount is fitted as flatly as possible to the hull. Any increase in gap between hull and transducer face can result in reduced performance.

The transducers will not work on wooden hulls to the extent that a transducer can be simply mounted within the hull; in such circumstances, through-hull mounting plates are required, whereby a plate is positioned on the outside of the hull. For similar reason, double-hulled grp hulls need similar through-hull mounting plates. It is known also to have depressions in the outside of the hull whereby the plates can be mounted and thereafter gel coat or similar compounds can be applied, whereby the hull hydrodynamics are not affected by the transducer plate.

Consideration must be taken into account of any bulkheads which can dissipate the ultrasonic signals. This may necessitate an increase in the number of transducers for a given length of boat. Equally, extra transducers may be required for complex stern gears and for boats that have deep keels, which also deaden the effect of the transducers.

If the mount is to be bonded to a metal hull, the use of a chemical metal two part epoxy is recommended. If the units are to be bolted down, then suitable studs can be welded into place. This removes the need for the hull to be drilled. Compound must be applied to the threads to stop any electrolysis between the fixings and the mount as this can occur if the materials are different. If the mount is being bonded into a fibreglass hull then any glass resin can be used to stick the mount into place.

One transducer has been found to provide sufficient protection for boats up to 6 m in length; ideally more transducers can be operated for larger boats; alternatively transducers with a greater operating power (cw) than 50 W could be employed, those skilled in the art will be able to determine the most appropriate solution. However, many issues can affect the performance, such as the material the boat is made from; the shape and submerged surface area. Applicants have conducted independent trials overseen by the University of Southampton and whilst tests are still ongoing, clear benefits have already been identified. The vessel is a Lochin 38, designed specifically for scientific use, including survey work, teaching, diving, and research. It operates out of Southampton and is currently licensed by the MCA allowing the vessel to operate at sea up to 60 miles from a safe haven. The boat has a large open deck and a spacious wheelhouse, equipped with lab benching and a sink and can comfortably accommodate a maximum of 12 passengers.

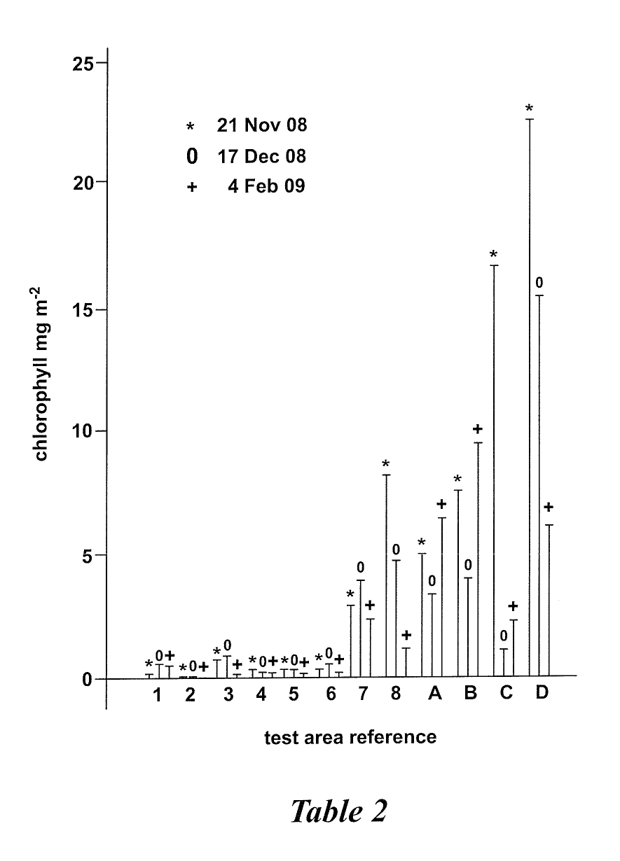

A displacement, keeled motor vessel of overall length of 12 m was fitted with two transducers, one for each side of the hull, as depicted in FIG. 4. A vertical rack of 4 of monitoring or control plates bear clear polycarbonate of 36×15 cm in size were deployed on the same day as the vessel was placed in the water. These plates were suspended from a pontoon approximately 10 m from where the vessel was moored, with the shallowest control plate being 15 cm below the surface and the deepest 120 cm below the surface. Whilst tests are presently proceeding with two transducers per side, initial tests were employed with one transducer per side. With reference to FIG. 4, the test area 3 corresponded to the position of the transducer, on the other, inside face of the hull. Test points 1 and 2 were designated for the rudder and a support member for a prop shaft, respectively, and were mechanically remote from the ultrasonic transducer. After five and a half months of testing, a report has commented “the minimal growth on the vessel's hull shows that it has been effective”. Control panels were situated in the vicinity of the test motor vessel and a further comment was made: “The minimal growth to date is only thin algal/diatom film and has had no effect on the vessel's performance. The control panels which have been in place since the start of the trial have a dense, 2 cm thick growth of fauna and algae which is not apparent anywhere on the vessel. The object of this study is to provide a control for comparison with the hull monitoring study. Plates will be left in place for the duration of the study to demonstrate the settlement that could occur on an unprotected surface . . . . After 5 autumn and winter months, there was patchy cover of well grown algae, bryozoa and seasquirts (ascidians). The set of plates facing out from the pontoon (light) was almost exclusively red and green algae covered, that facing the darker underneath of the pontoon, almost exclusively bryozoans and ascidians. Cover was extensive but not total, the plates surface visible between. There was some settlement of barnacles and calcareous tube worms and a few mobile species in the turf (scale worm and brittlestar) . . . .”

Accordingly, it has been independently shown that the present invention provides anti-fouling capabilities at a much reduced average power consumption over known systems. Tests are presently proceeding with two transducers per side of the hull. When two or more transducers are employed, then the transducers can be operated sequentially; the same basic controller can be used for boats both small and large; effectively, the power source must be sufficient to provide adequate power when the boat is not powered up whereby generators can maintain batteries in good operating condition. Equally, when moored at a marina, or other berth where there is a power supply, then the 12/24V d.c circuit need not be utilised, rather a mains power transformer rectifying circuit can be employed.

It will be appreciated that the low duty cycle of operation of the transducers significantly increases the duration of a power supply or reduces the number of units of electrical energy consumed by a boat at a marina berth or whilst at a harbour, where costs for such power supplies can sometimes bear little resemblance to the charges applied by a supplying utility company.

The system works by transmitting inaudible pulses of ultrasound at precise levels for set durations. These ultrasonic waves create microscopic bubbles that adhere to the hull of the boat. The bubbles implode (cavitation), producing an intense cleaning effect along the hull. Existing algae algal slime attached to the hull is broken down and further algae algal bodies are prevented from attaching and growing on the hull.

Without this first growth layer of algae layer of growth on a hull, other marine life such as barnacles, worms and weeds will not attach or grow. This leaves a clean, low drag surface. The hull transducers clean and protect a boat's hull from fouling in a very simple way. The transducers create microscopic vibrations along the surface of the hull. These ultrasonic sound waves from the transducer create an expansion and contraction cycle of the water molecules. When the transducers operate in a specific manner, the expansion of the water molecules creates a cavity. When immediately followed by a contraction cycle, the cavity bubble collapses due to the higher surrounding pressure. The bubble will then implode releasing gasses and jets of liquids in a violent implosion. Tens of thousands of bubbles experience cavitation every second. Combined, these implosions gently clean the surface of the boat, breaking the cell walls of the algal slime, which then ceases to adhere. If the initial algal slime is unable to adhere to the boat, subsequent colonisers (such as barnacles) will not attach.

The system is designed to minimise the current required when operating the transducers. It controls the transducers so that they are not “always on”. Instead they are only switched on for the length of time required to be effective. This ensures the hourly power consumption is exceedingly low. Preferably, the device also ensures that the transducers work in sequence, without wave interference between sound waves produced by separate transducers at any one time.

1. An anti-fouling arrangement for a boat, the arrangement comprising a controller, an ultra-sonic transducer and an transducer driver, wherein the controller provides control signal for the transducer driver whereby the transducer can be driven at its operating frequency and voltage, wherein the transducer is operable on a cyclic basis having an on period of 10 and 60 seconds followed by an off period of 5 and 60 minutes.

2. An anti-fouling arrangement according to claim 1, wherein the on period is between 10 and 20 seconds and the off period is between 10 and 30 minutes.

3. An anti-fouling arrangement according to claim 1, wherein, upon receiving an instruction signal to operate, the transducer driver receives feedback whereby to obtain maximum power for a given input voltage/power value, the feedback system operating on a self-optimising routine whereby to achieve maximum output power at resonance taking into account operating conditions.

4. An anti-fouling arrangement according to claim 1, wherein the operating conditions taken into account include one or more of the following factors; temperature, geographical location, salinity of water; resonance; number of transducers associated with controller.

5. An anti-fouling arrangement according to claim 1, wherein the ultra-sonic transducer is a piezo-electric transducer.

6. An anti-fouling arrangement according to claim 1, wherein the power supply is conveniently a 12V or 24 V dc supply derived from a low voltage power supply employed to operate the electrical circuits within the boat.

7. An anti-fouling arrangement according to claim 1, wherein the transducer is connected to the hull via a flange which retains the transducer in a circularly cylindrical body, an end face being provided with an ultrasonic transducer element, the transducer element being coupled to the hull via an acoustic couplant.

8. An anti-fouling arrangement according to claim 1, wherein the transducer is connected to the hull via a flange which retains the transducer in a circularly cylindrical body, an end face being provided with an ultrasonic transducer element, the transducer element being coupled to the hull via an acoustic couplant, wherein the flange is mounted to the hull by one of a weld, resin and fibre, glue or mechanical bolts.

9. An anti-fouling arrangement according to claim 1, wherein the transducer is driven by a driving circuit that includes a detector and a feedback circuit, the detector being operable to monitor output power whereby to vary a frequency of operation until a resonant maximum output is achieved.

10. An anti-fouling arrangement according to claim 1, wherein the systems has a control circuit, the control circuit having a fault detection circuit that is based around pre-set parameters based upon operational characteristics of a particular transducer.

11. An anti-fouling arrangement according to claim 1, wherein the control unit operates by providing control signals to each transducer in turn.

12. An anti-fouling arrangement according to claim 1, wherein the transducer is inserted in a flange arrangement, which has a through-hull fitment, whereby to provide a closed end face which can lie at or just below the surface of the hull, the inside of the closed end face being in an acoustically coupled arrangement with the ultrasonic face of the transducer element.

13. An anti-fouling arrangement according to claim 1, wherein the transducer is inserted in a flange arrangement, which has a through-hull fitment, whereby to provide a closed end face which can lie just below the surface of the hull, the inside of the closed end face being in an acoustically coupled arrangement with the ultrasonic face of the transducer element and wherein, upon fitment, the gap is filled with a filler compound whereby to provide a surface that is level with the surface about the through hull flange.

14. A method of reducing the build-up of fouling of a boat, the arrangement comprising a controller, an ultra-sonic transducer and a transducer driver, wherein the controller provides control signals for the transducer driver whereby the transducer, in contact with the hull of the boat, can be driven at its operating frequency and voltage, the method comprising the steps of operating the transducer on a cyclic basis having an on period of between 10 and 60 seconds followed by an off period of between 5 and 60 minutes.

15. A method according to claim 14, wherein, the transducer is driven by a driving circuit that includes a detector and a feedback circuit, the detector being operable to monitor output power whereby upon start-up, the method also includes the step of tuning the frequency of operation until a maximum output power is achieved.
